(19) United States
(12) Patent Application Publication
(10) Pub. No.: US 2003/0034772 A1
(43) Pub. Date: Feb. 20, 2003

(54) Rotatable magnetic plastic target wheel

(76) Inventors: Jose Antonio Galvan, Juarez (MX); Steven Edward Faetanini, Sandusky, OH (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 09/932,207

(22) Filed: Aug. 17, 2001

(51) Int. Cl. G01P 3/48; G01P 3/54

(52) U.S. Cl. 324/174

(57) ABSTRACT

Rotatable target wheels mount plastic ring magnets with increased magnetic flux for driving either digital or variable reluctance, magnetic wheel rotation sensors. The ring magnets are adhesively secured and optionally captured on a ring support member to provide dependable operation in vehicle wheel speed sensing and other applications.

### TECHNICAL FIELD

This invention relates to magnetic target wheels or encoders for use in providing a source of magnetic flux for sensing applications.

### BACKGROUND OF THE INVENTION

It is known in the art to provide a magnetic target wheel or encoder in the form of a rotatable disc having a molded rubber magnetic coating around its outer rim. The magnetic flux strength which these encoders are capable of generating is enough for digital applications, but is not sufficient for variable reluctance (VR) applications. Both economic and application advantages could be obtained if an improved target wheel was available with sufficient magnetic flux strength for use in both digital and VR applications.

### SUMMARY OF THE INVENTION

The present invention provides embodiments of magnetic target wheels carrying magnets with increased magnetic flux strength suitable for use in both digital and VR applications and providing improved utility and a reduced manufacturing cost. In a generic form, the target wheel includes a support member having a support ring including a connector for mounting the wheel on a rotatable member. The support ring carries a molded plastic ring magnet generating a magnetic flux adequate for both digital and variable reluctance sensing applications. The encoder may include a radial flange and optionally an annular rim extending axially from the flange. In one embodiment, a plastic ring magnet is adhesively fixed directly to the radial flange and positioned coaxially around the axis of rotation of the wheel. In another embodiment the plastic ring magnet is fixed to an interior surface of the annular rim and is preferably secured thereto by a suitable adhesive. The supporting portions including the support ring, connector and radial flange, if provided, may be formed as a unitary stamping formed with a magnetic steel. Optionally for suitable applications the support ring may be made of a nonmagnetic metal or as a molded plastic member.

These and other features and advantages of the invention will be more fully understood from the following description of certain specific embodiments of the invention taken together with the accompanying drawings.

### BRIEF DESCRIPTION OF THE DRAWINGS

In the drawings:

FIG. 1 is a plan view of a first embodiment of magnetic target wheel according to the invention;

FIG. 2 is a cross sectional view from line 2-2 of FIG. 1;

FIG. 3 is an enlarged view of the portion in circle 3 of FIG. 2;

FIG. 4 is a pictorial view of the target wheel of FIGS. 1-3;

FIG. 5 is a plan view of an alternative embodiment of target wheel according to the invention;

FIG. 6 is a cross sectional view from the line 6-6 of FIG. 5;

FIG. 7 is an enlarged view of the portion in circle 7 of FIG. 6; and

FIG. 8 is a pictorial view of the target wheel of FIGS. 5-7.

### DESCRIPTION OF THE PREFERRED EMBODIMENT

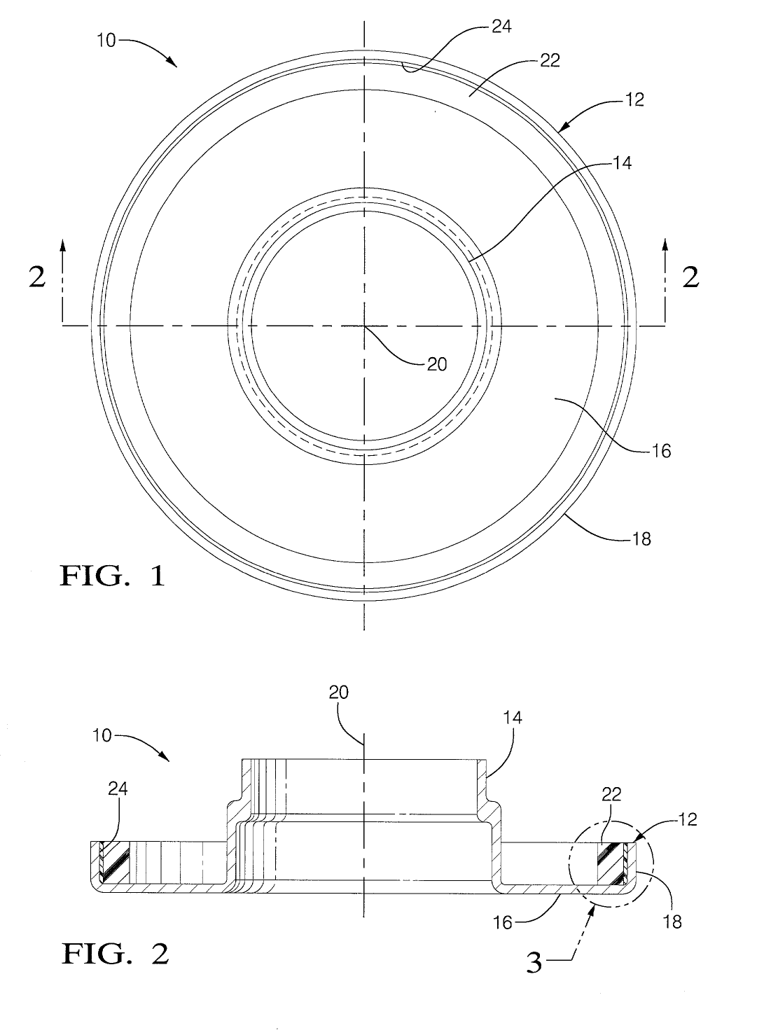

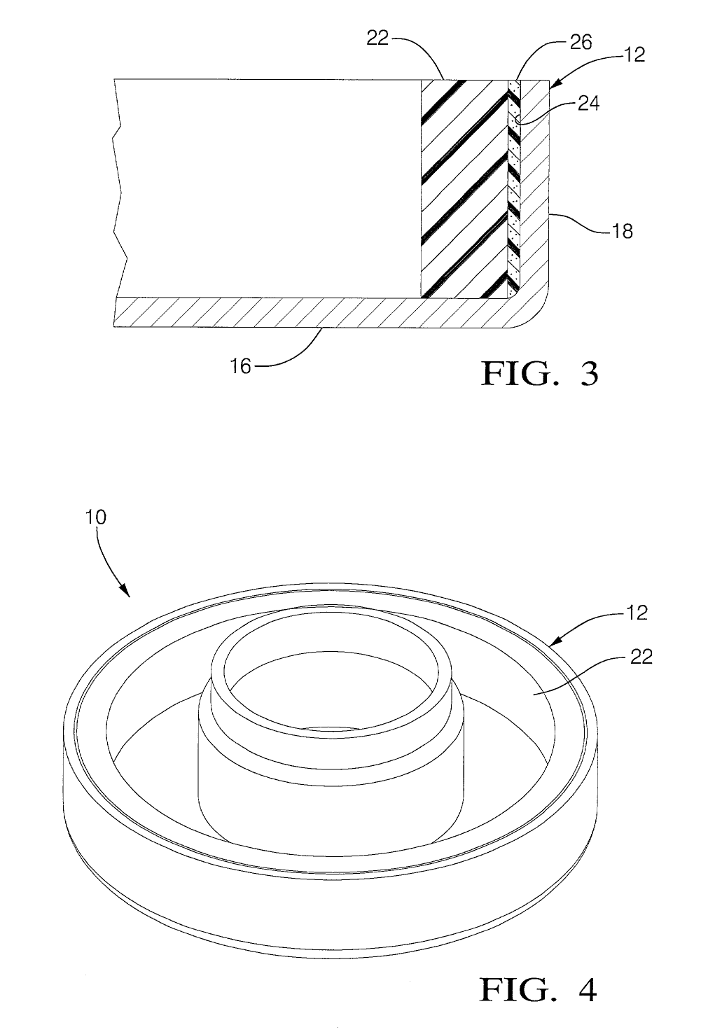

Referring first to FIGS. 1-4 of the drawings in detail, numeral 10 generally indicates a first embodiment of target wheel in accordance with the invention. Wheel 10 includes a stamped support member 12 which includes a hub 14, a radial flange 16 carried by the hub and an annular rim 18 extending axially from the outer periphery of the annular rim. The support member forms a wheel that is rotatable about a central axis 20.

Hub 14 acts as a connector for connecting the target wheel to a rotatable member such as a vehicle wheel. The connector could take other forms as needed. For example, the radial flange could have fastener openings through an inner portion for attaching the target wheel to a rotating body.

The radial flange 16 connects the hub 14 radially with the annular rim 18. A molded plastic ring magnet 22 is carried on an inner surface 24 of the annular rim 18 and is secured in place by a suitable adhesive 26 such as high temperature glue or epoxy. The plastic ring magnet is molded and carries magnetic particles having an overall flux strength adequate to provide sufficient flux for variable reluctance (VR) as well as digital applications. The support member 12 is preferably stamped from sheet magnetic steel, but may be formed from any suitable nonmagnetic metal or, alternatively, a suitable plastic material. FIG. 4 is a pictorial view of the completed target wheel 10.

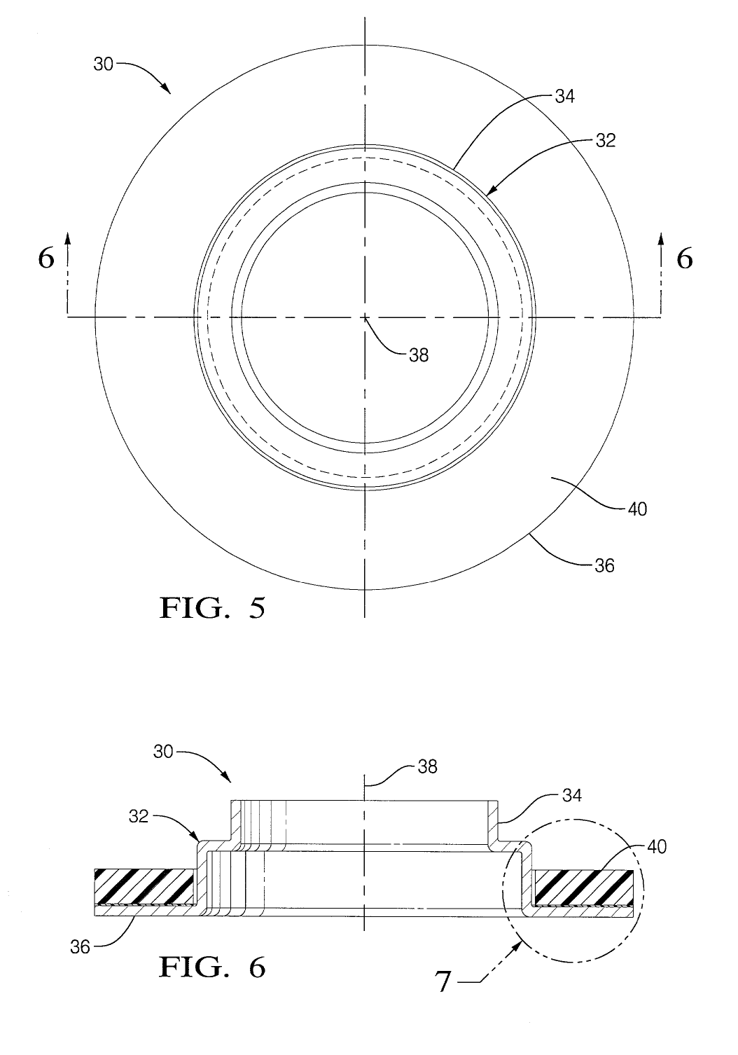

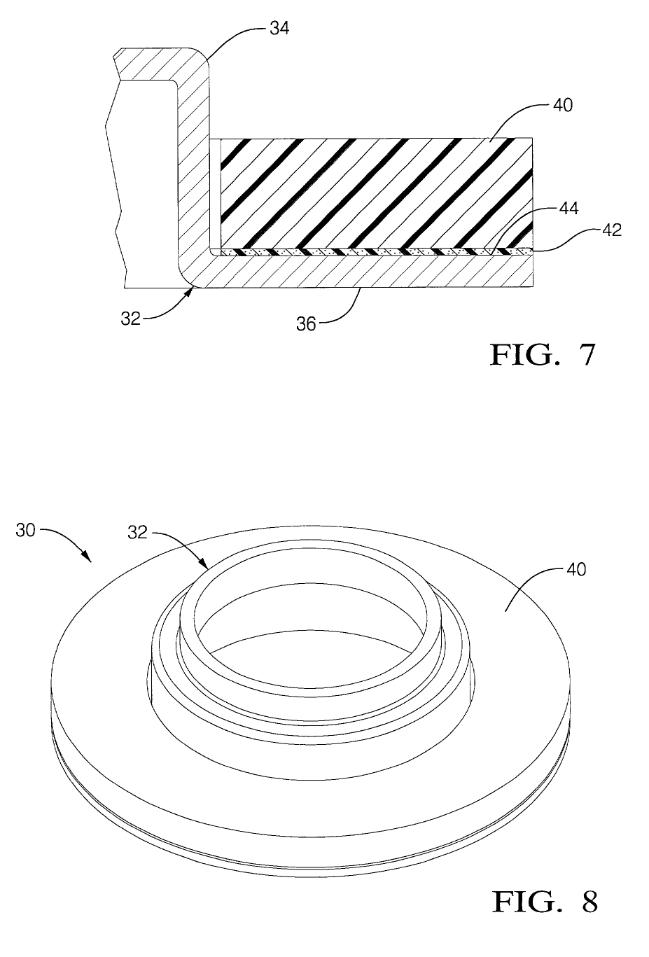

Referring now to FIGS. 5-8, numeral 30 generally indicates an alternative embodiment of magnetic target wheel in accordance with the invention. Target wheel 30 includes a support member 32 including a hub 34 and a radial flange 36 supported by the hub. The hub and flange forming the support member are preferably made as a stamping from a magnetic steel sheet. If desired, a nonmagnetic metal or a suitable plastic material could be used to form the support member. The support member is concentric about a central axis 38 which forms a rotational axis for the wheel. The hub 34 acts a connector for attaching the support member to a rotatable member such as a vehicle wheel. Other suitable forms of connectors could be used if desired as in the first embodiment.

The radial flange 36 directly carries a plastic ring magnet 40 which is attached by a suitable adhesive 42, such as high temperature glue or epoxy, to a radial face 44 of the radial flange 36. The ring magnet 40 is positioned concentrically on the radial face so that it is rotatable about the axis 38 in a concentric and balanced fashion that avoids the application of any shear forces to the adhesive 42 holding the ring magnet 40 to the radial flange 36.

This second embodiment of FIGS. 5-8 differs from the first embodiment by the manner of mounting of the ring magnet on the support member. In the first embodiment, the magnet 22 is contained within the annular rim 18 so that centrifugal forces of the magnet are directly applied against the rim 18 and the adhesive 26 is subject only to compressive forces. In the second embodiment of FIGS. 5-8, the magnet 40 is mounted to a radial face 44 so that the adhesive could be subject to shear forces if the plastic ring magnet is caused to expand due to centrifugal force or temperature changes. However, use of a proper adhesive will maintain the magnet in place under all conditions. Thus the selection of a particular embodiment for use in a sensing application is primarily determined by the location of the sensor which reacts to the magnetic flux in order to determine wheel speed or rotational speed of another member to which the target wheel 10 or 30 may be attached.

Both embodiments illustrated, as well as other variations referred to, provide easily manufactured target wheels capable of universal use for both digital and VR applications.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A magnetic target wheel comprising:
a rotatable support ring;
a connector on the support ring connectable to a rotatable member; and
a plastic ring magnet fixed to the support ring and rotatable therewith about a central axis, the magnet having a magnetic flux strength adequate for both digital and variable reluctance rotational velocity sensing applications.

2. A magnetic target wheel as in claim 1 wherein said support ring includes a radial flange by which the magnet is supported.

3. A magnetic target wheel as in claim 2 wherein the radial flange carries an annular rim with an interior surface mounting the magnet.

4. A magnetic target wheel as in claim 3 wherein the magnet is adhesively secured to the rim.

5. A magnetic target wheel as in claim 2 wherein the magnet is mounted to the radial flange.

6. A magnetic target wheel as in claim 5 wherein the magnet is adhesively secured to the flange.

7. A magnetic target wheel as in claim 1 wherein the support ring is formed from magnetic steel.

8. A magnetic target wheel as in claim 7 wherein the support ring is formed as a stamping including an integral hub

9. A magnetic target wheel as in claim 8 wherein the magnet is mounted on the support ring.

10. A magnetic target wheel as in claim 8 wherein the stamping includes a radial flange having an inner surface on which the magnet is mounted.
